(19) United States
(12) Patent Application Publication
(10) Pub. No.: US 2007/0005468 A1
(43) Pub. Date: Jan. 4, 2007

(54) System and method for asset/liability modeling

(75) Inventors: Richard Feller, Oakton, VA (US); Wendell Cape, Alexandria, VA (US); Stacy Dudas, Rockville, MD (US); Karen Gilmore, Oak Hill, VA (US); Raymond Loycano, Stafford, VA (US); Thomas Mitchell, Woodside, NJ (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Lynchval Systems Worldwide, Inc., Chantilly, VA (US)

(21) Appl. No.: 11/334,746

(22) Filed: Jan. 19, 2006

Related U.S. Application Data
(60) Provisional application No. 60/644,566, filed on Jan. 19, 2005.

(51) Int. Cl. G06Q 40/00

(52) U.S. Cl. 705/35

(57) ABSTRACT

A computer system (e.g., and method) includes an input device for inputting valuation data, a display device for displaying asset/liability modeling (ALM) data, and a central processing unit (CPU) for utilizing an ALM software application to process the valuation data to generate the ALM data, and generating for display on the display device a display screen which includes the ALM data and a mechanism for incorporating the ALM data into another software application.

### BACKGROUND OF THE INVENTION

1. Field of the Invention

The present invention generally relates to a system (and method) for asset/liability modeling and, more particularly, a system for asset/liability modeling which includes a display screen which includes asset/liability modeling (ALM) data and a mechanism for incorporating the ALM data into another software application.

2. Description of the Related Art

FIG. 1 illustrates a conventional user interface 100 for a conventional retirement benefits plan analyzer (as disclosed, for example, in U.S. Patent Pub. No. 2004/0039667A1 to Winklevoss et al.). In the conventional analyzer, a user inputs a change in experience assumptions, plan design, actuarial assumptions or asset mix, thus providing a hypothetical value for a variable relating to the retirement benefit plan. A benefits and liability extractor receives this input change and determines plan benefits and liabilities by either finding the exact values from the benefit payments and liabilities matrix or by using an interpolation algorithm.

The analyzer includes input capital market assumptions, a capital market simulator and investment return. The investment return has both an n-year and m-trial dimension. In addition, plan assets, benefit payments and liabilities, and actuarial methodology are used to determine contributions, accounting expense and benefit payments.

In the conventional user interface 100, a selector 101 allows the user to select one of a set of financial variables. With a selector 102, the user can select to freeze one of the three dimensions (year, mix or percentile). In this example, the output shows all years and all mixes, but only the 95th percentile of results because the percentile dimension is selected to be frozen.

The user interface 100 also includes a box 103 for selecting a graph type, and an output graph 104 that shows that there are 20 years and two asset mixes in the analysis, labeled Asset Mix 1 and Asset Mix 2. The user interface 100 is intended to efficiently presently projection data to a plan sponsor.

However, such conventional analyzers may be cumbersome and difficult for a user to utilize effectively. Specifically, it is difficult for a user to incorporate the information generated by the analyzers into another software application. Thus, for example, if a user wants to prepare a presentation to present the results generated by the analyzer using Microsoft® Powerpoint, the use would be require to input the results into a Powerpoint file from scratch, which is very time-consuming and inefficient.

### SUMMARY OF THE INVENTION

In view of the foregoing and other exemplary problems, drawbacks, and disadvantages of the conventional systems and methods, a purpose of the exemplary aspects of the present invention is to provide a system (and method) for asset/liability modeling which is efficient, easy to use and allows a user to easily incorporate the ALM data into another software application.

An exemplary aspect of the present invention includes a computer system, including an input device for inputting valuation data, a display device for displaying asset/liability modeling (ALM) data, and a central processing unit (CPU) for utilizing an ALM software application to process the valuation data to generate the ALM data, and generating for display on the display device a display screen which includes the ALM data and a mechanism for incorporating the ALM data into another software application.

Another exemplary aspect of the present invention includes a computer-implemented method of performing asset/liability modeling. The method includes inputting valuation data using an input device, utilizing an ALM software application to process the valuation data to generate ALM data, and generating a display screen which includes the ALM data and a mechanism for incorporating the ALM data into another software application.

Another exemplary aspect of the present invention includes an Internet-based system for performing asset/liability modeling. The system includes a webserver which is connected to the Internet and stores an asset/liability modeling (ALM) software application, and a plurality of user terminals connected to the webserver via the Internet, and including an input device for inputting valuation data, a display device for displaying ALM data, and memory which may store a web browser application. The webserver includes a central processing unit (CPU) for utilizing the ALM software application to process the valuation data to generate the ALM data, and generating for display on the display device a display screen which includes the ALM data and a mechanism for incorporating the ALM data into another software application.

Another exemplary aspect of the present invention includes a programmable storage medium tangibly embodying a program of machine-readable instructions executable by a digital processing apparatus to perform the computer-implemented method for asset/liability modeling, according to the exemplary aspects of the present invention.

With its unique and novel features, the present invention provides a system (and method) for asset/liability modeling which is efficient, easy to use and allows a user to easily incorporate the ALM data into another software application.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a conventional user interface 100 for a conventional retirement benefits plan analyzer;

FIG. 2 illustrates a system 200 for asset/liability modeling, according to an exemplary aspect of the present invention;

FIG. 3 illustrates an ALM selection screen 300, according to another exemplary aspect of the present invention;

FIG. 4 illustrates a funding screen 400, according to another exemplary aspect of the present invention.

FIG. 5 illustrates a Financial Accounting Standards Board (FASB) screen 500, according to the exemplary aspects of the present invention;

FIG. 6 illustrates an ALM charts screen 600, according to the exemplary aspects of the present invention;

FIG. 7 illustrates a details screen 700, according to the exemplary aspects of the present invention;

FIG. 8 illustrates a reports screen 800, according to the exemplary aspects of the present invention;

FIG. 9 illustrates a method 900 for asset/liability modeling, according to the exemplary aspects of the present invention;

FIG. 10 illustrates an Internet-based system 1000 for performing asset/liability modeling, according to the exemplary aspects of the present invention;

FIG. 11 illustrates a typical hardware configuration which may be used for implementing the system and method according to the exemplary aspects of the present invention; and

FIG. 12 illustrates a programmable storage medium 1200 tangibly embodying a program of machine-readable instructions executable by a digital processing apparatus to perform the method for asset/liability modeling according to the exemplary aspects of the present invention.

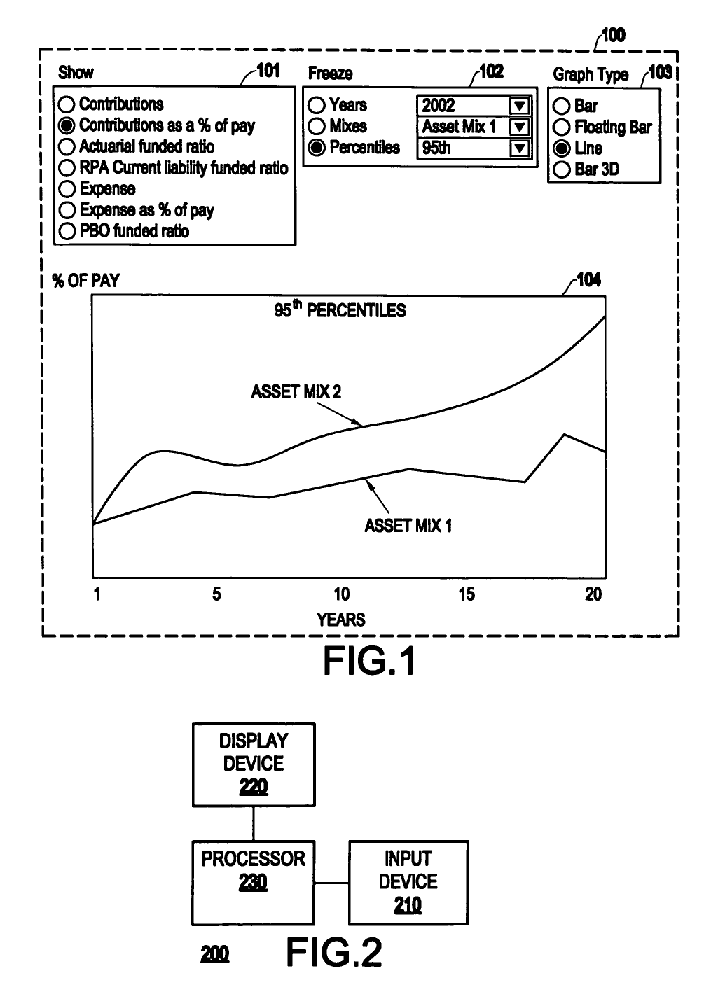

### DETAILED DESCRIPTION OF EXEMPLARY EMBODIMENTS OF THE INVENTION

Referring now to the drawings, and more particularly to FIGS. 2-12, there are shown exemplary embodiments of the method and system of the present invention.

FIG. 2 illustrates a computer system 200 which may be used to asset/liability modeling, according to an exemplary aspect of the present invention. The system 200 may be used, for example, to generate a model a benefits plan (e.g., a pension plan or other plan to provide income to employees in retirement, such as a defined contribution plan, defined benefit plan, retiree health plan, or other PostEmployment Benefit plans).

The system 200 includes an input device 210 for inputting valuation data, a display device 220 for displaying asset/liability modeling (ALM) data, and a processor (e.g., central processing unit (CPU)) 230 for utilizing an ALM software application to process the valuation data to generate the ALM data, and generating for display on the display device a display screen which includes the ALM data and a mechanism for incorporating the ALM data into another software application.

Introduction

The inventors have invented a system and method for asset/liability modeling (e.g, a asset/liability modeling tool) which is efficient, easy to use and allows a user to easily incorporate the ALM data into another software application. The system and method has been implemented, for example, in LV-PALM, a Pension Asset/Liability Modeling tool offered by Lynchval Systems Worldwide, Inc.

The system 200 may allow a user (e.g., clients) to view and analyze output from a projection module run from software (e.g., Lynchval's asset/liability projection module run from Lynchval's valuation software). The output may be read from an open database connectivity (ODBC) compliant database and/or an ActiveX Data Objects (ADO) compliant database and stored in a schema designed to hold the ALM results.

Further, the system 200 (e.g., LV-PALM analysis and reporting tool) may allow a user to view graphs, reports, and data of the ALM data results by funding strategies, projection years, and economic scenarios including, for example, forecasted summary, financial accounting standards (FAS), Funding, Valuation, and Participant data.

An important feature of the system 200 is that data (e.g., graph data, report data, chart data, etc.) can be exported to files (e.g., bitmap files) that can be included into various other software applications (MS Word®, Excel®, Powerpoint, etc). The system 200 may also support a number of specified standard graphs (e.g., bar graphs, pie charts, etc.) and reports.

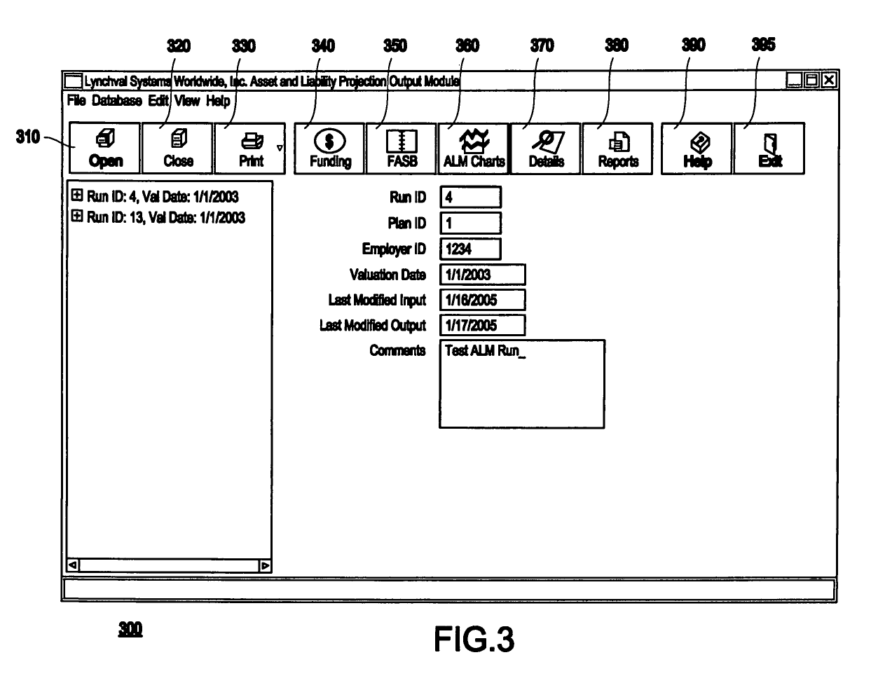

For example, the system 100 may generate (e.g., for display on a display device 220) a main welcome screen which is a login screen that may allow a user to select a database to connect to and display ALM results. To access ALM data results, the user may utilize the main welcome screen to select a “login” hot link to display the login dialog and enter a user ID and password. This may cause the system 200 to generate an ALM selection screen 300 (e.g., FIG. 3) which may allow the user to select an ALM run (e.g., a single ALM run) from a database connected to the system 200. That is, the ALM selection screen 300 may allow a user to select from multiple ALM runs stored in a single database (e.g., or a plurality of databases).

The user may select the ALM run, for example, by double clicking on the run in the tree on the left side of the screen 300 or selecting the “Open” button from the top button bar. The ALM selection screen 300 may also display a list of ALM forecasts saved to the connected database that a user can select to open and view the ALM data results.

Specifically, the ALM selection screen 300 may include an icon 310 which may be selected (e.g., by moving a mouse over the icon and clicking the mouse) for opening a file and/or database (e.g., client file, client database, etc.), an icon 320 for closing a file and/or database, and an icon 330 for printing data (e.g., raw data (e.g., valuation data) input by the user, or ALM data generated by the system 200).

The screen 300 may also include an icon 340 for selecting a funding screen, icon 350 for selecting an FASB screen, icon 360 for selecting an ALM charts screen, icon 370 for selecting a details screen, icon 380 for selecting a reports screen. For example, if the user clicks on the icon 340, the system 100 will generate the funding screen which is displayed on the display device 210, and so on. The screen 300 may also include a help icon 390 for generating a help screen, and an exit icon 395 for exiting the ALM software application.

An important feature of the present invention is that these icons (e.g., icons corresponding to icons 310-395) may be displayed on any of the screens 300-800 (e.g., FIGS. 3-8, respectively). This allows the user to easily move between screens in the system 200.

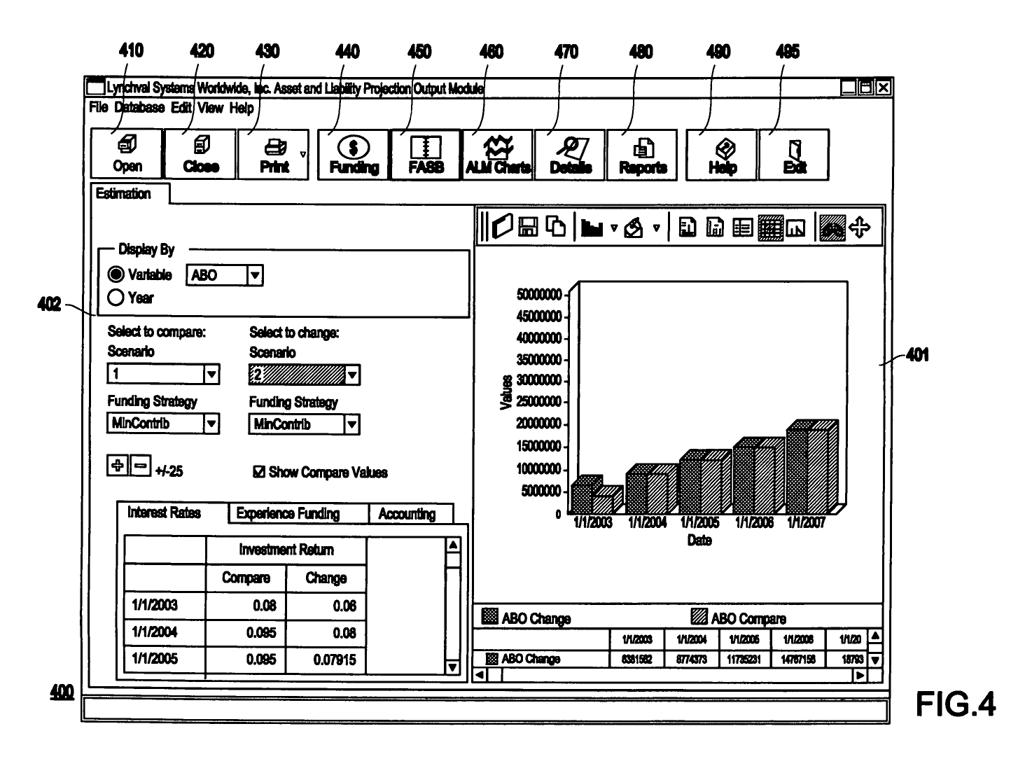

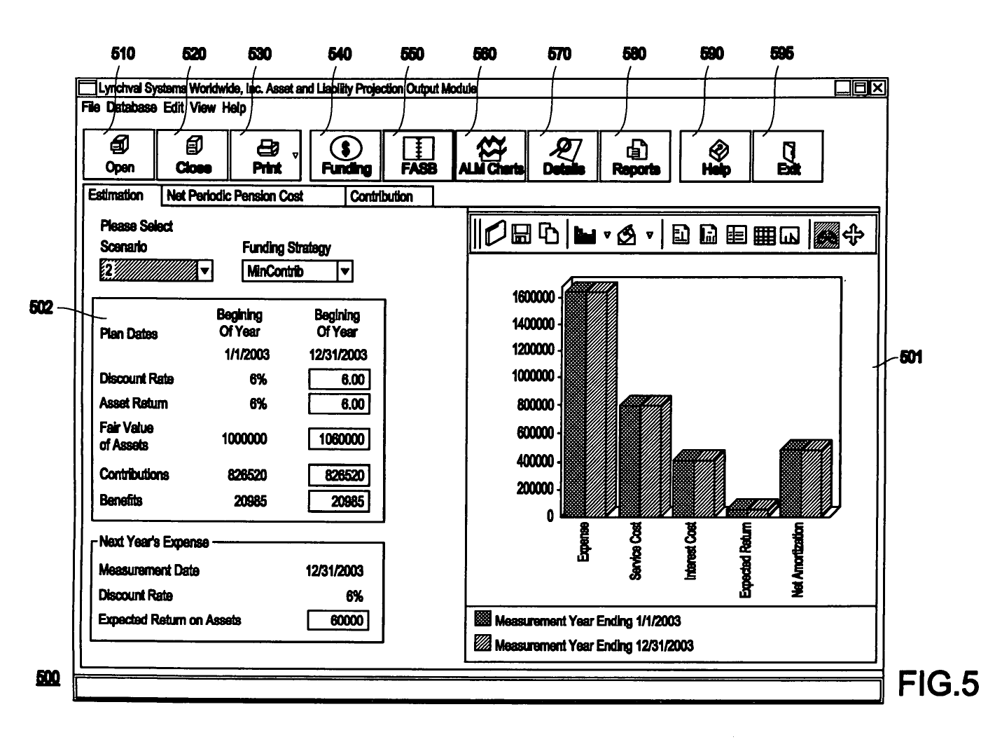

The system 200 may also generate a funding screen 400 (e.g., FIG. 4) which may enable a user to view funding results by selected variables and/or by selected years and compare different scenario/funding strategies in graph format. The funding screen 400 may display a funding result for the forecasted period. The screen 400 may provide a user with the ability to select the results to display in the graph by a selected variable, year, scenario, and/or funding strategy.

The funding screen 400 may also provide a user with an ability to compare a plurality of scenarios and funding strategies (e.g., two scenarios and funding strategies) in the graph.

Further, the bottom grid on the left side of the screen 400 may display other results of the forecast for the selected scenario and funding strategy. Such results may include, for example, at least one of investment rate of return, interest rate used to calculate the liabilities, funding rates used to calculate the minimum/maximum, and other contributions.

In addition, to the icons 410-495 (e.g., corresponding to icons 310-395 in FIG. 3), the funding screen 400 may also include a region 401 for displaying ALM data (e.g., in bar graph format, chart format, textual or spread sheet format, etc.) generated by the ALM software application. The funding screen 400 may also include a control region 402 for controlling an ALM run. That is, control region 402 may display parameters selected, valuation data input, databases selected, etc.) which may be processed by the ALM software application to generate ALM data (e.g., results of an ALM run).

An important aspect of the present invention is that this format or a slight variation thereof, is utilized on screens 400-800 (e.g., FIGS. 4-8). That is the control region (e.g., 402) is displayed in close proximity with (e.g., side-by-side) with the region (e.g., 401) for displaying the results of an ALM run. This makes it convenient for a user to input and/or alter parameters, data etc., in the control region and quickly view a result of the ALM run.

The system 200 may also generate a FASB screen 500 (e.g., FIG. 5) which may enable a user to view the FAS costs by scenario and funding strategy and compare the beginning and end of year values (e.g., in graph format). The FAS screen 500 may display, for example, FAS 87 results for the forecasted period filtered by scenario and funding strategy. The screen 500 may also allow a user to change scenario assumptions and view the impact of the change (e.g., by viewing the graph).

In addition, to the icons 510-595 (e.g., corresponding to icons 310-395 in FIG. 3), the FASB screen 500 may also include a region 501 for displaying ALM data (e.g., in bar graph format, chart format, textual or spread sheet format, etc.) generated by the ALM software application, and a control region 502 for controlling an ALM run.

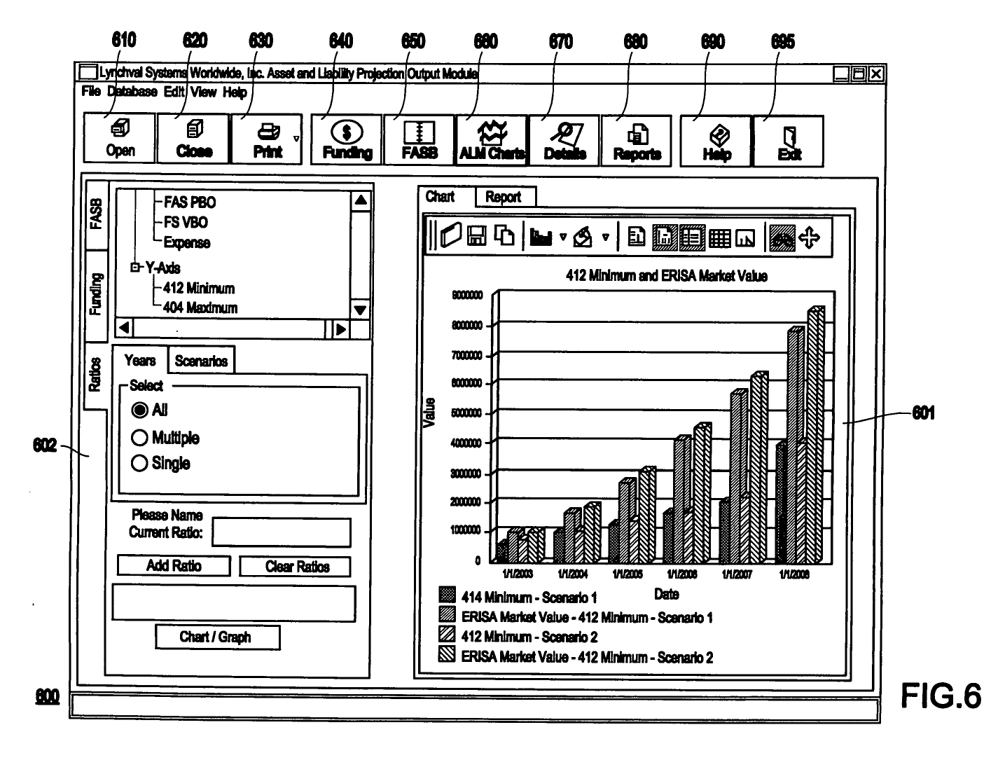

The system 200 may also generate an ALM charts screen 600 (e.g., FIG. 6) which may allow a user to chart and display any combination or ratio of contributions, assets, and liabilities for the forecasted period and display the combination or ratio in graph and/or report format. A user may also have the ability to limit results by years and scenarios in a forecasted period.

For example, the charts screen 600 may allow a user to view a trend of forecasted values by year, scenario, strategy, etc. The screen 600 may also provide user with an ability to calculate and view ratios of funding and FASB results. The screen 600 may also provide a user with an ability to filter the results by year and scenario and create groups of ratios of forecasted values.

In addition, to the icons 610-695 (e.g., corresponding to icons 310-395 in FIG. 3), the ALM charts screen 600 may also include a region 601 for displaying ALM data (e.g., in bar graph format, chart format, textual or spread sheet format, etc.) generated by the ALM software application, and a control region 602 for controlling an ALM run.

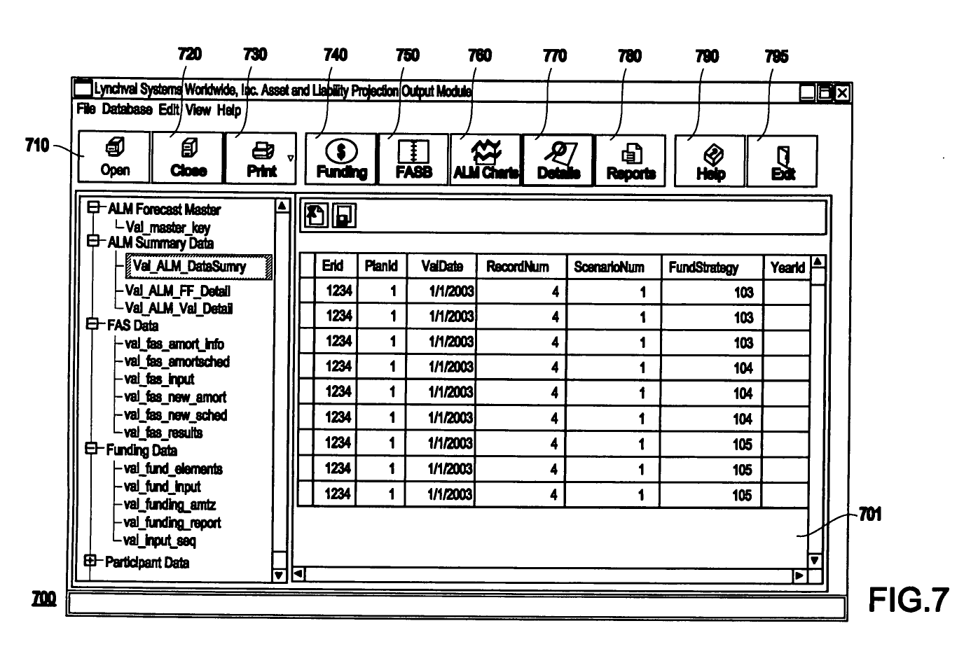

The system 200 may also generate a details screen 700 (e.g., FIG. 7) which may display data (e.g., all data) used in the ALM forecast (e.g., used to generate ALM data). The detail screen 700 may allow a user to view, for example, all data produced by the ALM run and extract the data to multiple formats (e.g., spreadsheet (e.g., MS Excel®), word processing (e.g., MS Word, etc.) and incorporate the ALM result data in another application (e.g., another application which may be external (e.g., separate or different from) the ALM software application).

In addition, to the icons 710-795 (e.g., corresponding to icons 310-395 in FIG. 3), the details screen 700 may also include a region 701 for displaying ALM data (e.g., in bar graph format, chart format, textual or spread sheet format, etc.) generated by the ALM software application, and a control region 502 for controlling an ALM run.

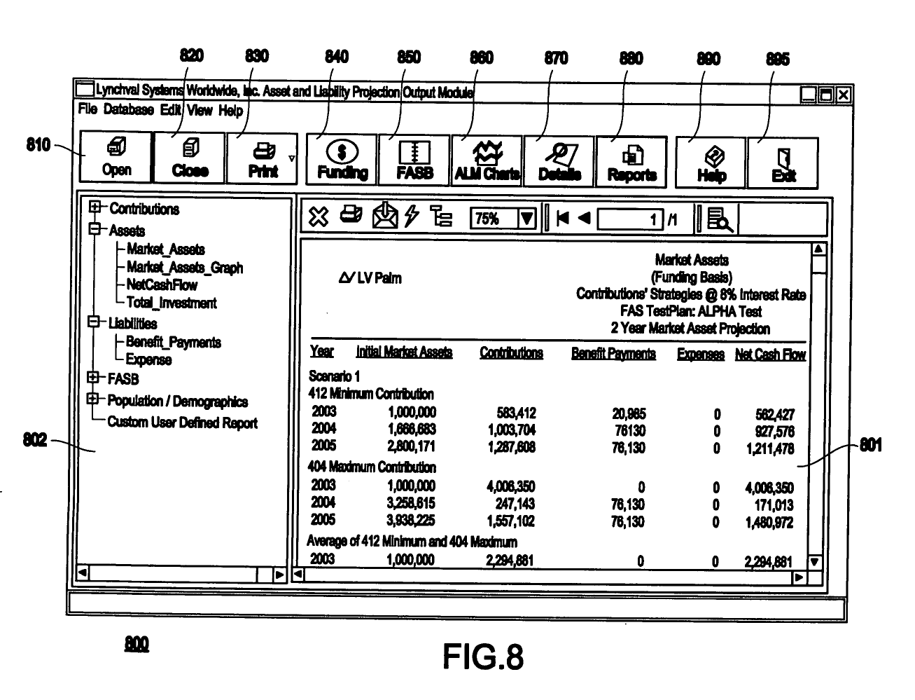

The system 200 may also generate a reports screen 800 (e.g., FIG. 8) which may allow a user to select from a list of standard reports or add custom reports and view report results. The reports screen 800 may allows a user to select from a list of reports (e.g., standard company reports) and may also provide user with an ability to incorporate user custom reports designed using another software application (e.g., Crystal Reports).

In addition to the icons 810-895 (e.g., corresponding to icons 310-395 in FIG. 3), the reports screen 800 may also include a region 801 for displaying ALM data (e.g., in bar graph format, chart format, textual or spread sheet format, etc.) generated by the ALM software application, and a control region 802 for controlling an ALM run.

An important feature of the system 200 is that the screens generated by the system (e.g., screens 300-800) may allow a user to view and export the results that can be incorporated into another application (e.g., an external application). That is, the screens (e.g., views) generated by the system 200 may include a mechanism (e.g., an icon) for incorporating data (e.g., valuation data, ALM data, etc.) into another software application.

Thus, a user may easily select data (e.g., graph data) displayed on the screen (e.g., by using a mouse to move a cursor over the data and clicking the mouse) and copy (e.g., save) the data into a word processing application, presentation application, etc.

Referring again to FIG. 2, the system 200 may move ALM data (e.g., ALM result data) to another software application which may include, for example, one of a word processing application, a spreadsheet application, a presentation application, a photo-editing application, and a media player application. Further, the ALM data generated by the system 200 (e.g., based on the input valuation data) may be in the form of a graph and/or chart which can be incorporated into the other software application.

Further, the mechanism for incorporating the data (e.g., ALM data) into the other software application may include a mechanism for utilizing the input device 210 to copy and paste the ALM data into the other software application. The mechanism may also include a mechanism for utilizing the input device to save the ALM data (e.g., in a file, folder, etc.) in a form which is utilizable by the other software application.

Further, the mechanism for incorporating the ALM data into the other software application may include an icon and/or a drop down menu on the display screen. For example, the user may use the input device (e.g., a mouse) to locate a curser over the icon and click, which may cause another screen or drop down menu to be displayed. From this screen or menu, the user may use the input device to select an application type (e.g., word processor, spreadsheet, etc.) and a manner for moving the data (e.g., save to a file, copy and paste, etc.).

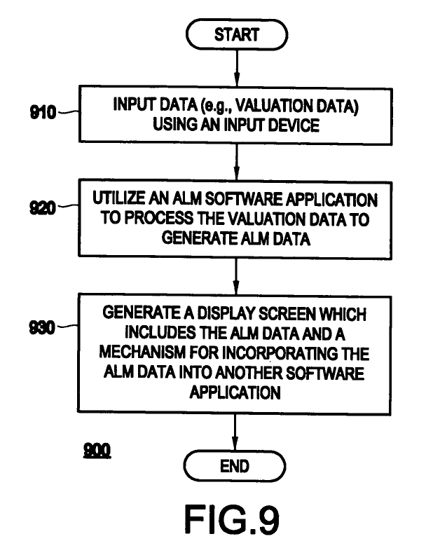

Referring to FIG. 9, another exemplary aspect of the present invention includes a computer-implemented method 900 of performing asset/liability modeling. The method 900 includes inputting (910) data (e.g., valuation data) using an input device, utilizing (920) an ALM software application to process the valuation data to generate ALM data, and generating (930) a display screen which includes the ALM data and a mechanism for incorporating the ALM data into another software application.

The method 900 may also include, for example, (e.g., in chronological order) generating a login screen for allowing a user to select a database to connect to and display asset/liability modeling (ALM) results, generating a selection screen for displaying a list of ALM forecasts, generating a funding screen for enabling a user to view a funding result by one of selected variables and selected years and compare different scenario/funding strategies in a graph format, generating a Financial Accounting Standards Board (FASB) screen, for enabling the user to view the financial accounting standards (FAS) costs by scenario and funding strategy and compare the beginning and end of year values in graphical format, generating an ALM chart for allowing a user to chart and display any combination or ratio of contributions, assets, and liabilities for the forecasted period and display them in graphical and report format, generating a detail screen for displaying data used in the ALM forecast, and generating a reports screen for allowing a user to at least one of select from a list of standard reports, add custom reports, and view report results.

Internet-Based System

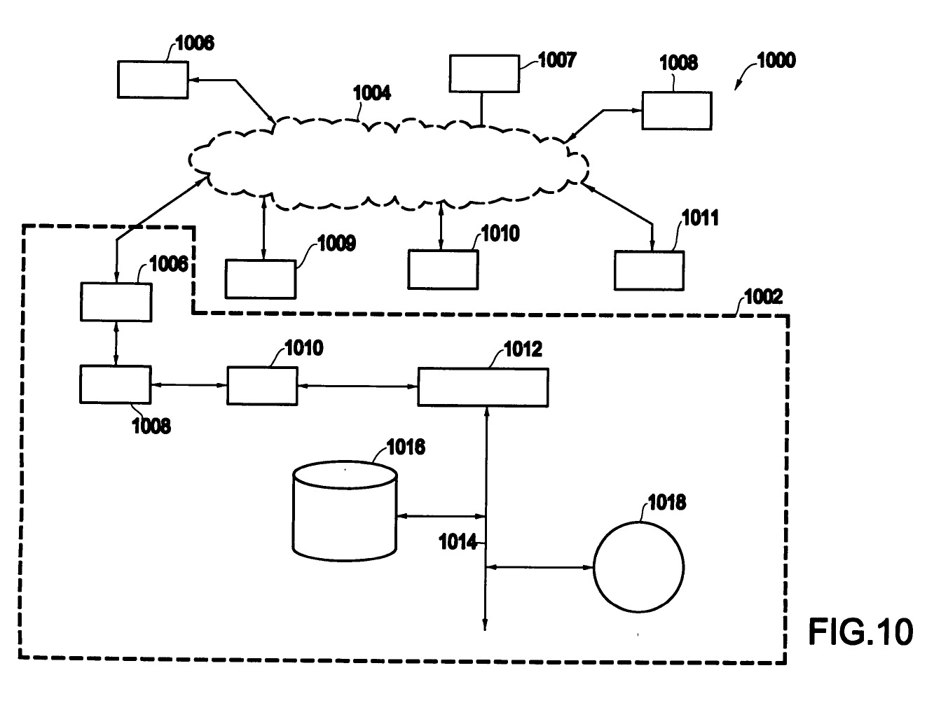

FIG. 10 illustrates an Internet-based system 1000 for performing asset/liability modeling. The system 1000 includes a webserver 1002 which is connected to the Internet 1004 and stores an asset/liability modeling (ALM) software application. The system 1000 further includes a plurality of user terminals 1006-1011 connected to the webserver via the Internet 1004, and including an input device for inputting valuation data, a display device for displaying ALM data, and memory which may store a web browser application.

The webserver 1002 includes a processor (e.g., central processing unit (CPU)) for utilizing the ALM software application to process the valuation data to generate the ALM data, and generating for display on the display device a display screen which includes the ALM data and a mechanism for incorporating the ALM data into another software application.

That is, the present invention may be implemented using a communication medium which includes a network of interconnected user terminals such as the Internet (e.g., a global network of computers), in which routers move an information packet between network levels, and from network to network, until it reaches the appropriate user terminal. The network includes routing hubs having domain name system (DNS) servers using Transmission Control Protocol/Internet Protocol (TCP/IP), and connecting one or more other routing hubs via high speed communication links.

Specifically, the system may be implemented as a website on the World Wide Web (WWW) which is supported by the Internet. The website may include a computer (e.g., server) for storing documents and generating a display on a user terminal which displays graphical and textual information. The website may be defined by an Internet address that has an associated electronic page (e.g., a document that organizes the presentation of text, graphics, images, audio, video, etc.) which is identified by a Uniform Resource Locator (URL).

The webserver 1002 (e.g., website) may be connected via the Internet 1004 to the plurality of user terminals 1006-1011 (e.g., for a client, customer, etc.). The user terminals 1006-1012 may include a personal computer (e.g., desktop, notebook, etc.) having a display device, input device (e.g., keyboard, mouse, etc.), memory (e.g., RAM, ROM, etc.) which may store a web browser (e.g., Netscape Communicator, Microsoft® Internet Explorer, etc.), and microprocessor which causes the user terminal to generate a display screen (e.g., graphical user interface (GUI)) on the display device.

The webserver 1002 may include a network interface controller (NIC) 1006 for interfacing with the Internet 1004. The webserver 1002 may also include an interactive webpage user interface 1008 (e.g., Microsoft® Active Server Pages (ASP)), and an Internet file and application server 1010 (e.g., Microsoft® Internet Information Server (IIS)), that runs under control of an operating system 1012 (e.g., Microsoft® Windows-NT server). The ASP 1008 and IIS 1010 may together generate a web presence on the Internet. The webserver 1002 may also include an expansion bus 1014 which supports a database 1016 and a general purpose storage disk 1018 for storing the ALM software application and/or various other programs (e.g., Microsoft® Windows-NT services such as Microsoft® SQL Server, Microsoft® Exchange Server, Dynamic Host Interface Protocol (DHCP), and Windows Internet Name Service (WINS) servers) for supporting the website.

The Internet-based system 1000 may have a function which is similar to the function of the system 200. That is, a user may use a web browser which may be stored, for example, on his user terminal (1006-1011), to interface with the website via the Internet. The system 1000 may generate on the display device of the user terminal, the login screen, the selection screen, the funding screen, the Financial Accounting Standards Board (FASB) screen, the ALM chart screen, the detail screen, and/or the reports screen, as described above with respect to system 200. However, unlike the system 200, the system 1000 may store the ALM software application on the website, so that a party that maintains the website may be responsible for maintaining (e.g., updating) the ALM software application.

Further, the Internet-based system 1000 may allow a user to purchase (e.g., from the website owner) a right to utilize the ALM software application via the Internet. For example, the website may include a screen for allowing user to select to “subscribe” to the website by entering credit card information, Paypal™ information, etc. Such a subscription would allow the user to access the ALM software application via the Internet from the user terminal. Thus, as an alternative to purchasing the ALM software application and installing it on his user terminal, the user may just purchase a subscription to the website, and use the website to perform an asset/liability modeling.

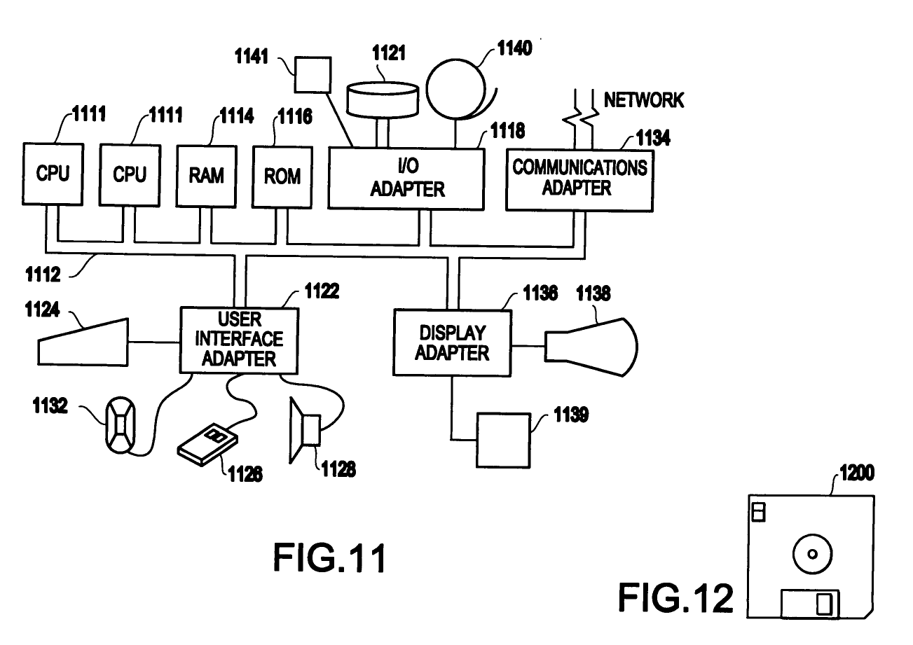

Referring again to the drawings, FIG. 11 illustrates a typical hardware configuration which may be used for implementing the computer system and method according to the exemplary aspects of the present invention. The configuration has preferably at least one processor or central processing unit (CPU) 1111. The CPUs 1111 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, and Intranet, a personal area network (PAN), etc., and a display adapter 1136 for connecting the bus 1112 to a display device 1138 and/or printer 1139. Further, an automated reader/scanner 1141 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions.

These instructions may reside in various types of signal-bearing media. Thus, this aspect of the present invention is directed to a programmed product, including signal-bearing media tangibly embodying a program of machine-readable instructions executable by a digital data processor to perform the above method.

Such a method may be implemented, for example, by operating the CPU 1111 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 1111 and hardware above, to perform the method of the invention.

This signal-bearing media may include, for example, a RAM contained within the CPU 1111, as represented by the fast-access storage for example. Alternatively, the instructions may be contained in another signal-bearing media, such as a magnetic data storage diskette 1200 (FIG. 12), directly or indirectly accessible by the CPU 1111.

Whether contained in the computer server/CPU 1111, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C” etc.

With its unique and novel features, the present invention provides a method and system for requesting help which may eliminate the need for a help-desk person, and may, therefore, provide significant cost savings to an organization.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A computer system, comprising:
an input device for inputting valuation data;
a display device for displaying asset/liability modeling (ALM) data; and
a central processing unit (CPU) for:
utilizing an ALM software application to process said valuation data to generate said ALM data; and
generating for display on said display device a display screen which includes said ALM data and a mechanism for incorporating said ALM data into another software application.

2. The computer system of claim 1, wherein said another software application comprises one of a word processing application, a spreadsheet application, a presentation application, a photo-editing application, and a media player application.

3. The computer system of claim 1, wherein said display screen displays said ALM data in the form of a graph which can be incorporated into said another software application.

4. The computer system of claim 1, wherein said display screen displays said ALM data in the form of a chart which can be incorporated into said another software application.

5. The computer system of claim 1, wherein said mechanism for incorporating said ALM data into another software application comprises a mechanism for utilizing said input device to copy and paste said ALM data into said another software application.

6. The computer system of claim 1, wherein said mechanism for incorporating said ALM data into another software application comprises a mechanism for utilizing said input device to save said ALM data in a form which is utilizable by said another software application.

7. The computer system of claim 1, wherein said mechanism for incorporating said ALM data into another software application comprises an icon on said display screen.

8. The computer system of claim 1, wherein said mechanism for incorporating said ALM data into another software application comprises a drop-down menu located on said display screen.

9. The computer system of claim 1, wherein said display screen comprises a detail screen which displays ALM data used in an ALM forecast.

10. The computer system of claim 1, wherein said CPU generates for display on said display screen a login screen for allowing a user to select a database to connect to and display said ALM data.

11. The computer system of claim 1, wherein said CPU generates for display on said display screen a selection screen for displaying a list of ALM forecasts.

12. The computer system of claim 1, wherein said CPU generates for display on said display screen a funding Screen for enabling a user to view a funding result by one of selected variables and selected years and compare different scenario/funding strategies in a graph format.

13. The computer system of claim 1, wherein said CPU generates for display on said display screen a Financial Accounting Standards Board (FAS) screen, for enabling the user to view the financial accounting standards (FAS) costs by scenario and funding strategy and compare the beginning and end of year values in graph format.

14. The computer system of claim 1, wherein said CPU generates for display on said display screen an ALM chart for allowing a user to chart and display one of contributions, assets, and liabilities for the forecasted period, and any combination thereof.

15. The computer system of claim 14, wherein said CPU generates said ALM chart in one of a graph format and a report format.

16. The computer system of claim 1, wherein said CPU generates for display on said display screen a reports screen for allowing a user to at least one of select from a list of standard reports, add custom reports, and view report results.

17. A computer-implemented method of performing asset/liability modeling, said method comprising:
inputting valuation data using an input device;
utilizing an ALM software application to process said valuation data to generate ALM data; and
generating a display screen which includes said ALM data and a mechanism for incorporating said ALM data into another software application.

18. The method of claim 17, further comprising:
generating a login screen for allowing a user to select a database to connect to and display asset/liability modeling (ALM) results;
generating a selection screen for displaying a list of ALM forecasts;
generating a funding screen for enabling a user to view a funding result by one of selected variables and selected years and compare different scenario/funding strategies in a graph format;
generating a Financial Accounting Standards Board (FASB) screen, for enabling the user to view the financial accounting standards (FAS) costs by scenario and funding strategy and compare the beginning and end of year values in graphical format;
generating an ALM chart for allowing a user to chart and display any combination or ratio of contributions, assets, and liabilities for the forecasted period and display them in graphical and report format;
generating a detail screen for displaying data used in the ALM forecast; and
generating a reports screen for allowing a user to at least one of select from a list of standard reports, add custom reports, and view report results.

19. An Internet-based system for performing asset/liability modeling, comprising:
a webserver which is connected to the Internet and stores an asset/liability modeling (ALM) software application; and
a plurality of user terminals connected to said webserver via the Internet, and comprising an input device for inputting valuation data, a display device for displaying ALM data, and memory which may store a web browser application,
wherein said webserver comprises a central processing unit (CPU) for:
utilizing said ALM software application to process said valuation data to generate said ALM data; and
generating for display on said display device a display screen which includes said ALM data and a mechanism for incorporating said ALM data into another software application.

20. A programmable storage medium tangibly embodying a program of machine-readable instructions executable by a digital processing apparatus to perform the computer-implemented method for asset/liability modeling, according to claim 17.
